(19) United States
(12) Patent Application Publication
(10) Pub. No.: US 2014/0365335 A1
(43) Pub. Date: Dec. 11, 2014

(54) INSPECTION SYSTEM AND METHOD

(71) Applicant: VINSPECTOR, LLC, San Francisco, CA (US)

(72) Inventor: Anthony TYSHUK, San Francisco, CA (US)

(21) Appl. No.: 14/296,439

(22) Filed: Jun. 4, 2014

Related U.S. Application Data
(60) Provisional application No. 61/831,147, filed on Jun. 5, 2013.
(60) Provisional application No. 61/884,899, filed on Sep. 30, 2013.

(51) Int. Cl. G06Q 30/06

(52) U.S. Cl. CPC G06Q 30/0623
USPC 705/26.61

(57) ABSTRACT

An item such as a vehicle is displayed graphically on an interactive display as a collection of item components that are mapped to a global code set. The user selects one or more components and indicates per-component and per-type exceptions, which are indicated graphically as markers on the display of the item. The user may optionally view exception entered by previous users.

### CROSS-REFERENCE TO RELATED APPLICATIONS

This application claims priority of U.S. Provisional Patent Application 61/831,147, filed 5 Jun. 2013 and U.S. Provisional Patent Application 61/884,899, filed 30 Sep. 2013.

### BACKGROUND OF THE INVENTION

Inspections are routinely carried out on many items, both stationary and movable. Some of the almost countless examples include: appraisals with condition reports performed on real property; aircraft; power grid transformers; pipelines; ships and other watercraft; buildings; even the containers in which other goods are shipped. Even people are sometimes “inspected”, such as during a physical examination, either routine, after a multiple-injury accident, or otherwise. In short, modern life has many examples of instances in which one wants to be able to inspect something and annotate observations.

One of the most continually evaluated and inspected of items are vehicles. A consumer renting a vehicle, for example, may be asked to perform a visual inspection of the condition of the vehicle and affirm it by signature, and a customer service representative often must note damage both before and after a renter drives a car. Auto repair facilities also inspect a vehicle and require the owner to sign off on its condition upon arrival.

When a vehicle is being transported it will be inspected several times at points along the supply chain. A typical inspection record for a vehicle is a paper form with a list denoting the presence or absence of certain ancillary Items (spare tire, jack, stereo system, etc.) and fields to record data such as odometer readings, color, license plate, make and model. Invariably there will be a graphic upon which will be marked various designations representing location and character of damage. The surface condition of the vehicle represents a significant liability risk for whichever actor within the supply chain the vehicle is entrusted to at the time. Surface areas, both interior and exterior, are the most common sections of a vehicle to be damaged. Even the slightest scratch or mar represents a significant liability, especially when it comes to new cars, whose potential buyers are likely to be intolerant of even minor blemishes. When a new car goes through the final step in the supply chain and is delivered to the dealer or customer, any surface damage no matter how minute must be immediately repaired; otherwise, the car is not sellable as new. The dealer will normally invoice back the manufacturer or distributor for the repair bill, which is usually significant since the entire panel on which the damage occurred may need to be re-painted. The manufacturer or distributor may then attempt to ascertain liability for the damage in order to receive restitution.

Vehicle supply chains, especially ones with an international or overseas character, may be composed of multiple actors responsible for different series of actions: initial transportation from the manufacturing facility; loading onto a ship or within a shipping container; stowing; blocking, bracing, removal of same; unloading; storage at a port; transportation to a secondary storage facility; and transportation to a dealer are just some of the possible steps. Along the way it is routine to perform inspections whenever responsibility for the vehicle changes amongst the actors in the supply chain, with particular emphasis on surface defects. Defects of this nature must be located, observed and recorded via a manual process—due to variables of lighting, glare, operator skill and, most significantly, the possibility of the defect being extremely small, it is not practical to record instances of damage solely through digital photographic or video means. Furthermore, damage must be denoted in a clear and unambiguous way.

Condition reports vary in nature. At present, although some may be electronic, most are still recorded on paper and stored in files. Although these records exist in material fact, assembling all of them to provide a clear, aggregated record of the condition of the vehicle throughout all transportation steps can be very difficult, as they are typically stored as disparate records at many different locations and usually as pieces of paper. One consequence of recording and storing the reports as paper documents, or within isolated systems, is that comparisons to previous states of condition are difficult to ascertain. In short, paper files that may be located in many different places, some far apart, make it hard to track the history of the condition of a vehicle along the entire supply chain; for example, it may take inordinate time and effort to figure out during what stage of shipping a scratch arose that a dealer now sees on the side panel of a new car.

Some car rental companies enable a representative to annotate on the display of a mobile device, such as a tablet computer, that a particular car has scratches, dents or other damage. These systems still generally make it difficult to precisely indicate the position of damage, especially since they tend to use a pre-set, generic image of a vehicle. They also generally do not allow the user to indicate the type or extent of damage, but rather just involve making a small stylus mark somewhere on the generic vehicle image. Many of these systems do not even allow textual annotation of damage.

Note that a condition of interest doesn't have to be “bad”, such as vehicle damage. In some circumstances, there may be a requirement to affirmatively indicate when something is in proper order, such as a checklist, where some non-standard accessories may have been added, etc.

What is needed, not only in the context of vehicles in a supply chain but in other contexts that require inspections, is a way to more efficiently, easily, and precisely indicate conditions of interest. Depending on need, it will also often be advantageous to have a way to easily compile and track the history of such indications, such as over the course of a supply chain.

### BRIEF DESCRIPTION OF THE DRAWINGS

FIG. 1 illustrates one example of some of the possible users/actors involved in a typical vehicle supply chain scenario.

FIG. 2 illustrates a mobile device that is displaying a representation of an item of interest.

FIG. 3 illustrates a log-in procedure for the mobile device.

FIG. 4 illustrates a method for enabling a user to input location.

FIG. 5 shows one example of an input screen for capturing an item's identifier.

FIG. 6 illustrates an example of data that might be returned to the user relating to a car.

FIGS. 7-9 illustrate a method that enables users to input component- and location-specific markers, that is, indicators, relating to exceptions they find.

FIG. 10 illustrates a pre-submission confirmation procedure.

FIG. 11 illustrates four inspection steps in an example of a supply chain for a car.

FIG. 12 shows the flow of exception indicator entry and retrieval for a series of stages in an example supply chain.

FIG. 13 is a system diagram showing the main components in a user device and in servers with which it can interact.

FIG. 14 illustrates an automatic ID-capture embodiment.

### DETAILED DESCRIPTION

In general, the various embodiments disclosed here involve systems and related operating methods that provide an interactive graphical representation of components of an item, for example in a supply chain. Some embodiments are particularly advantageous where the different components map to respective codes that, at least per-item, are common to users throughout the supply chain, that is, common to all actors/users performing inspections in the chain. Because it is anticipated to be the most common implementation, different embodiments described below focus on a multi-actor supply chain, that is, an arrangement in which an item of interest is tracked and observed at different stages by different actors. This is not the only possible situation, however. The different stages don't necessarily have to be part of a “supply” chain, but could be any series of transactions, such as when an item changes owners. Indeed, it's not even necessary for there to be more than one “stage” or more than one actor/user. For example, some embodiments could be employed to advantage even by just a single user who wants a convenient system to record the state of components in some larger “item”, which could even be living, that is, a person or animal, being examined by a physician or veterinarian.

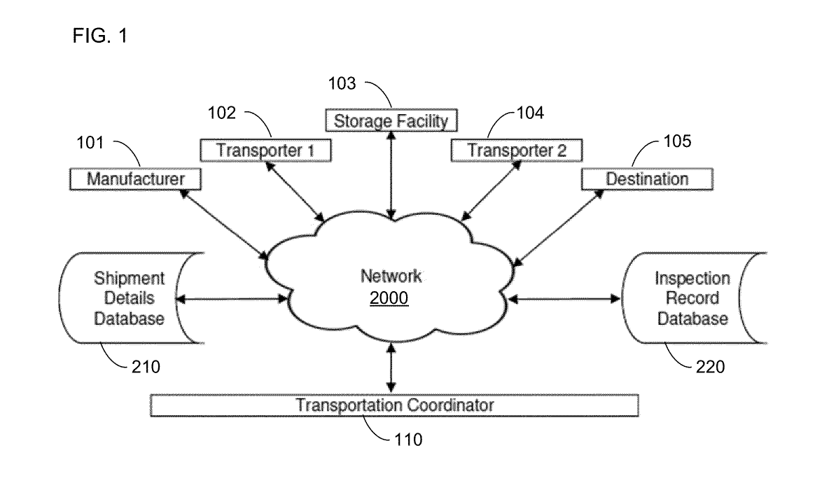

FIG. 1 illustrates possible actors involved in supply chain scenarios, together with a representation of information flow through a network 2000. In this example, the various actors include at least one manufacturer 101 of an item (for example, a vehicle), a first transporter 102 (for example, a trans-oceanic vehicle transport ship), a first storage facility 103 (for example at a receiving port), a second transporter 104 (for example, rail cars or trucks), to a destination 105 (such as a car dealership or rental agency). In most such situations, it is not unusual to have the overall supply chain managed by a transportation coordinator 110, which may be an independent third party contracted by any of the other actors.

The supply chain illustrated in FIG. 1 thus has, by way of example only, five “stages” or “steps”, that is, at least five points (corresponding to actors) where one might wish to inspect and record any exceptions (such as damage) that may have occurred to the item. Other scenarios may involve more or fewer steps and one advantage of the invention is its adaptability to such varying scenarios; in fact, embodiments of this invention can be used even with one “stage”, that is, in situations where there is only one user who performs inspections.

Also, note that an “exception” is any deviation from an expected condition or rule, both “good” and “bad.” Thus, not only could a scratch, dent or other form of damage be an exception, but, depending on the situation, finding an unexpected upgrade or extra accessory could also be an exception.

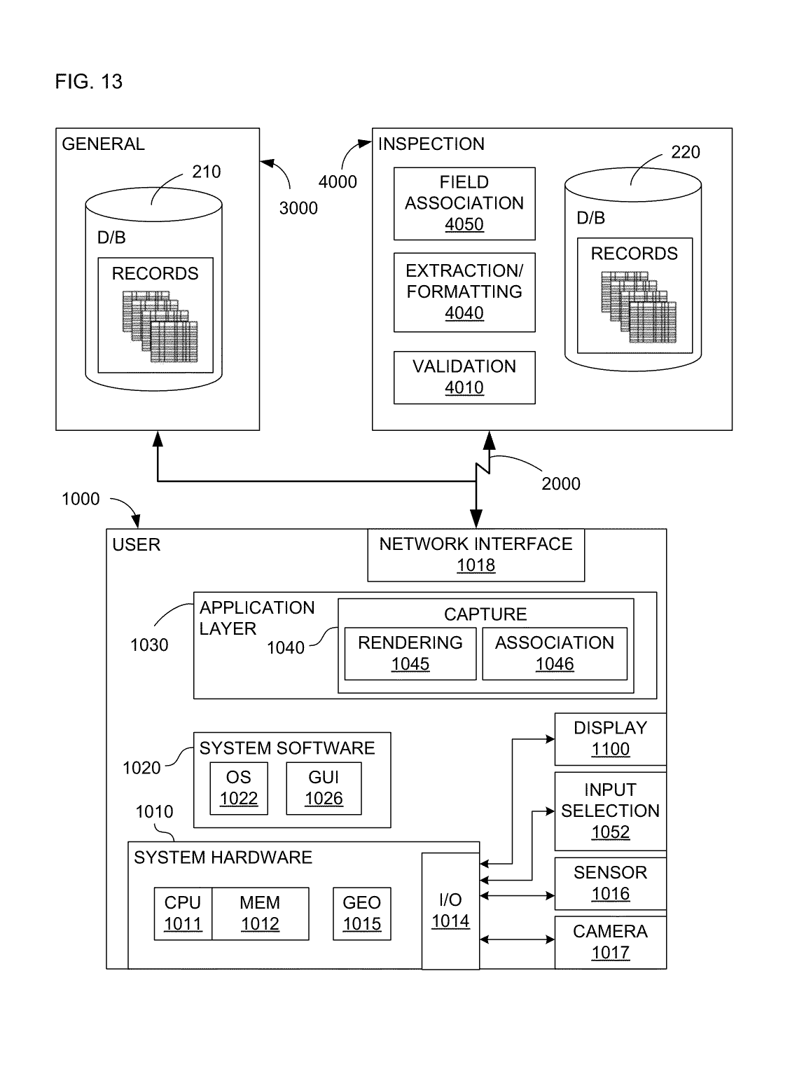

In conjunction with the following discussion of the various operational steps of different embodiments, refer also to FIG. 13, which illustrates system components that enable and carry out the various operations. FIG. 13 is also later discussed separately.

A database 210 will generally be included in or under the control of or accessed via a general server 3000, which, in this example, functions as a “shipment server.” The server 3000 and database 210, in one possible configuration, may be under the control of any of the actors or group of actors in the supply chain, although it would also be possible to have an independent agency control these components. In one scenario the Transportation Coordinator 110 may, for example, maintain shipment details about the item such as a unique identifier (for example, a VIN for a vehicle) and other data such as destination and consignee. Using known techniques, the party that controls the database 210 may grant and restrict access to the database 210, for example, depending on a privilege level established for each of the actors.

During the course of an inspection the system may retrieve shipment details from database 210 to complete the necessary information to generate a complete record of the shipment, which may then be stored in a database 220, which will be within or accessible by and via a corresponding inspection server 4000. The system might also or instead retrieve shipment details from database 210 each time an inspection is carried out to ensure the most up-to-date shipment details are stored. For example, the consignee might change at any point during the shipment process.

Shipment details may or may not be available from server 3000 dependent upon whether the corresponding actor has allowed access to their server and provided a mechanism, such as a web service, to facilitate access to shipment details. Whether shipment details are automatically accessed from server 3000 or obtained through a different methodology, the shipment details may thus be combined with data relating to inspection results and entered into and stored in database 220 and subsequently made available for retrieval.

In one embodiment, partial or complete data related to inspections at the different stages may also be entered into and stored in database 210. Partial or complete data related to an item stored within database 220 may be retrieved by any of the supply chain actors granted access by means of direct database access or through a web service provided by the system or by other means. In general, however, all actors will typically be able to access database 220, whereas the database 210 is preferably made accessible to only by those actors that are granted access privilege by the owner(s) of database 210.

Either or both of the databases may also be abstracted as “cloud storage”, that is, physically remote storage devices maintained, for example, by third parties. Either or both of the databases may, moreover, be comprised of multiple databases or other data storage systems. Other databases may also be implemented as needed to store other data the actors may prefer to have accessible. As used here, a “database” is simply any system or device or cooperating group of these that enables collection, storage, organization, and retrieval of data, regardless of what technology is used to implement it or how distributed this storage may be. By way of example only (see FIG. 13), the databases 210, 220 are shown as being part of or under the control of respective shipment and inspection servers 3000, 4000.

The network 2000 may be either general, such as the Internet or a telephone network, or a proprietary network such as may be implemented within a large enterprise. It is not necessary for all actors to use the same channel to access the databases or communicate with other actors. Indeed, it is not necessary for the databases to be separated from all actors by the network; rather, for example, the coordinator 110 could maintain one or more of the databases and access it directly, with no need for a network connection at all.

Information often flows among all parties involved: shipper, current location, condition, notifications to parties, estimated shipping time, estimated delivery date, final destination, consignee, destination agent, etc. Each party at some point may have a responsibility and/or liability to ensure the vehicle conforms to the shipping schedule and is delivered to the next party in the same condition as it was received, or in a new recorded condition.

Mobile devices that are able to present an interactive graphical user interface, perform computations, store data and communicate over a network with other devices, including database-management systems such as servers, have become all but ubiquitous. Different actors may use different such devices to access the network, retrieve information from and submit data for storage in the various databases.

Merely for the sake of simplicity, and without limitation, the following discussion will focus on an example embodiment in which the item to be tracked through a supply chain is a vehicle such as a car. As mentioned above, however, the item may be of any type that is amenable to inspection. Note that any given actor may participate in more than one supply chain at a time.

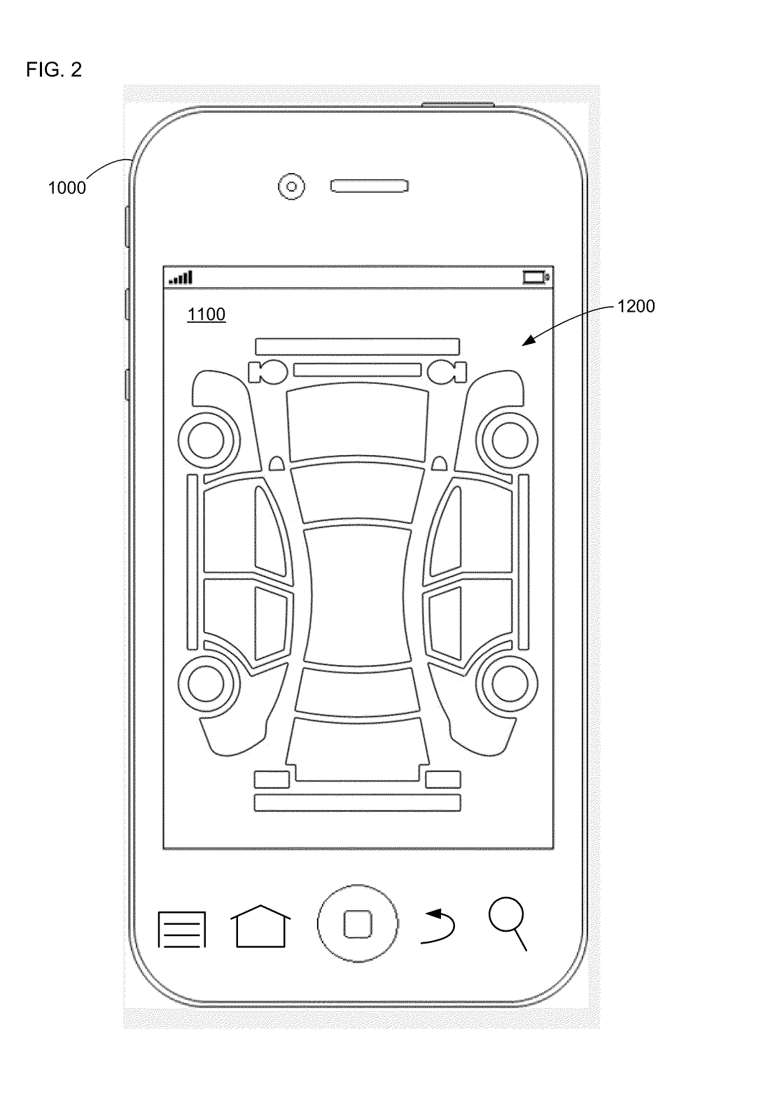

FIG. 2 illustrates a user (actor) mobile device 1000 that has an interactive display 1100 such that the user can not only see what's displayed, but also input information, such as through indications, such as by touching the display with a finger, stylus, etc. As with most such “smart” devices, the mobile device 1000 also preferably allows the user to see and input text via a physical or virtual keyboard, as is illustrated in other drawings.

FIG. 2 also illustrates that the display 1100 is displaying an “exploded” view of a car 1200. In other words, the item is, in this example, displayed as a stylized digital schematic image optionally rendered in a flattened perspective. The image may be generated and stored in any known format. In one prototype, the images were rendered using the Scalable Vector Graphics (SVG) format. The representation of the car (item) in this embodiment has at least two features that differ from what existing solutions offer: First, the car (the “item”) is shown not as a unit but rather as an arrangement of its components of interest. As explained further below, this allows the user to indicate exceptions (such as instances of damage, or even the presence of accessories or other features that are not expected) precisely.

Second, the representation of the car is not “generic”, that is, one-display-for-all, but rather different cars may be represented more precisely, according to their actual configuration. In other words, the vehicle being inspected is represented to the user as a set of individually selectable, consistently encoded components that more closely correspond to the actual vehicle configuration than is possible using existing systems. The general configurations and body styles of different types of vehicles can be derived from a modern 17-character VIN, which has character fields, for example, for brand, engine size and type, model year and even more specific features. A rendering component 1045 within the data capture application 1040 may therefore query and download rendering parameters from a database, such as the database 220, which may store the parameters (such as vector data or graphics files) needed to render the component-based representations for each respective vehicle corresponding to a current VIN of interest.

Each displayed component is therefore preferably associated with a corresponding identifying code that is established for all the users. Thus, component identifier CI(i) would indicate component i. For example, the four wheels could have the codes i=w1, w2, w3, w4 (with even more wheels and codes for additional wheels, such as a spare tire mounted on the exterior of the car, or fewer codes in the case of, for example, a motorcycle); the front windshield, rear window, front and rear side windows (glass) could have the identifiers g1-g6, and so forth. The manner and format for component identifiers will of course be chosen to suit the needs of a particular user group and the type of items being tracked. Note that the component identifiers need not be displayed as such to the user—the corresponding elements of the graphical display 1200 will in most cases be even easier for a user to interpret and interact with—but will be used as parameters to aid in efficient storage and indexing of user inputs in the inspection record database 220.

For any given item, such as type and model of vehicle, the codes to which the various components are mapped are preferably the consistent across the group of users who are inputting exceptions. Thus, if one user has marked a “Scratch” exception for a right front fender, then the code for that component (right front fender) should be interpreted the same way when other users' devices graphically render the car in component form. One example of a consistent, item- and component-specific code system that may be used in the context of vehicle inspections is found in the well-known, widely used Automotive Industry Action Group (AIAG) specification, which (version 2, April 2009) has 99 Damage Area codes, 38 Damage Type codes, and five Severity codes. For example, AIAG Damage Area codes 10, 22, 27, 66, and 81 correspond, respectively, to “Door—Left Front”, “Grille”, “Hood”, “Dash/Instrument Panel”, and “Gas/Cap Cover”.

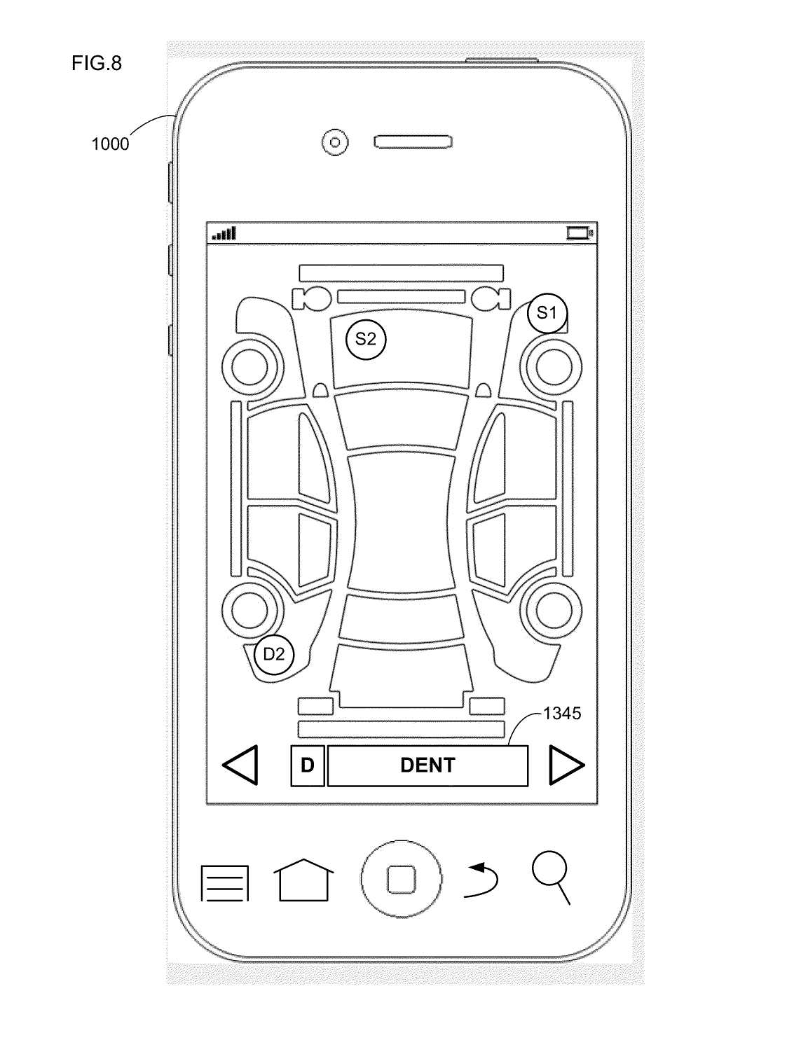

The 38 AIAG Damage Type codes include 1, 4, 11, and 36 indicate, respectively, “Bent”, “Dented”, “Punctured”, “Incorrect Part Or Option Not As Invoiced”, and so on. In the context of vehicle inspection, AIAG codes are one example of a standardized code scheme that could be used to determine which options are made available to the user via the graphical input device 1345 (FIG. 8). Other code systems may of course be used, depending on the preference and agreement of the actors in the supply chain.

Even within a standardized system such as AIAG, the coding system need not (but could be) “universal” or “global” in the sense of having a fixed mapping of all codes to specific component locations. For example, AIAG codes 32, 41, 46, 47, 51, 62, 87 and 88 are all (in version 2, April 2009) “open”, allowing for different manufacturers to give them different meanings. For example, code 46 might mean “Rea Camera Lens” for an Audi, but “Roll Bar” for a Chrysler Jeep. Given a VIN (or other item identifier, depending on the implementation) and knowledge (for example, pre-stored table) of the code system, however, the rendering component 1045 can assign the proper interpretation to each code for representation within user devices, which may change from item to item.

An identifier is also associated with the item (here: car) itself, so that it can be consistently tracked across the supply chain and properly represented in the display 1100. In general, the item may be identified according to any chosen convention by any combination of alphanumeric characters and even include symbols. Identifiers may also include electronic devices attached to the item, wirelessly transmitting a unique identification code for each item. Many products have standardized or manufacturer-specified serial numbers. In embodiments that involve shipping vehicles, there is already an internationally accepted identification convention, namely, in the form of the vehicle identification number (VIN), which is usually represented as a machine-readable code (such as a one- or two-dimensional bar or QR code or the like) that is affixed to the item. One attribute of the VIN number is that it encodes information about the vehicle such as make, model and year. For vehicles manufactured after the 1979 model year, the VIN is a 17-digit alphanumeric code that is unique to each vehicle. Because of its standardization, known routines, such as those described below for exception notation, can easily determine if a VIN number is correctly formatted before taking any further actions.

In some embodiments, the inspection database server 4000 (FIG. 13) may also generate a Primary Reference Number (PRN). The PRN may be an integer that can be automatically generated upon initialization of an inspection chain and may be used as a primary identifier for all data associated with the item. The PRN may thus form a primary index to identify the database records associated with a given chain of inspection results by different users. In one embodiment, the PRN is encoded into some machine-readable form and affixed to the item, or its container, or both. For example, the PRN may be encoded in a barcode sticker, or by correspondingly configuring or programming an active or passive RFID or Bluetooth or other wireless device capable of transmitting an identifier such as the PRN. In some embodiments, each item, once initially processed, thus has two reference numbers—the item identifier and a PRN. Applications within the embodiment of the invention can in such cases access information about the item using either number, since there will generally be a one-to-one mapping between the two.

In another embodiment, the PRN and additional information (as required) may be encoded into both some machine-readable form and human readable format and affixed to the item. Should the inspector be unable to electronically enter the machine-readable form it would then be possible to manually enter the PRN through the on-screen keyboard.

In another embodiment, the active or passive device (such as RFID or Bluetooth) could encode and transmit still another unique code, such that the item, once processed, may have three reference codes: VIN, PRN and electronically transmitted code. Each of the three reference codes may then be relationally correlated to each other within the database, for example, using a simple look-up table.

Now before delving into the system details of various aspects, consider how an inspection “session” might proceed at a given stage of the supply chain. In other words, assume that a user wants to inspect a car that has arrived on a loading dock, before formally “signing off” on receipt and assumption of responsibility.

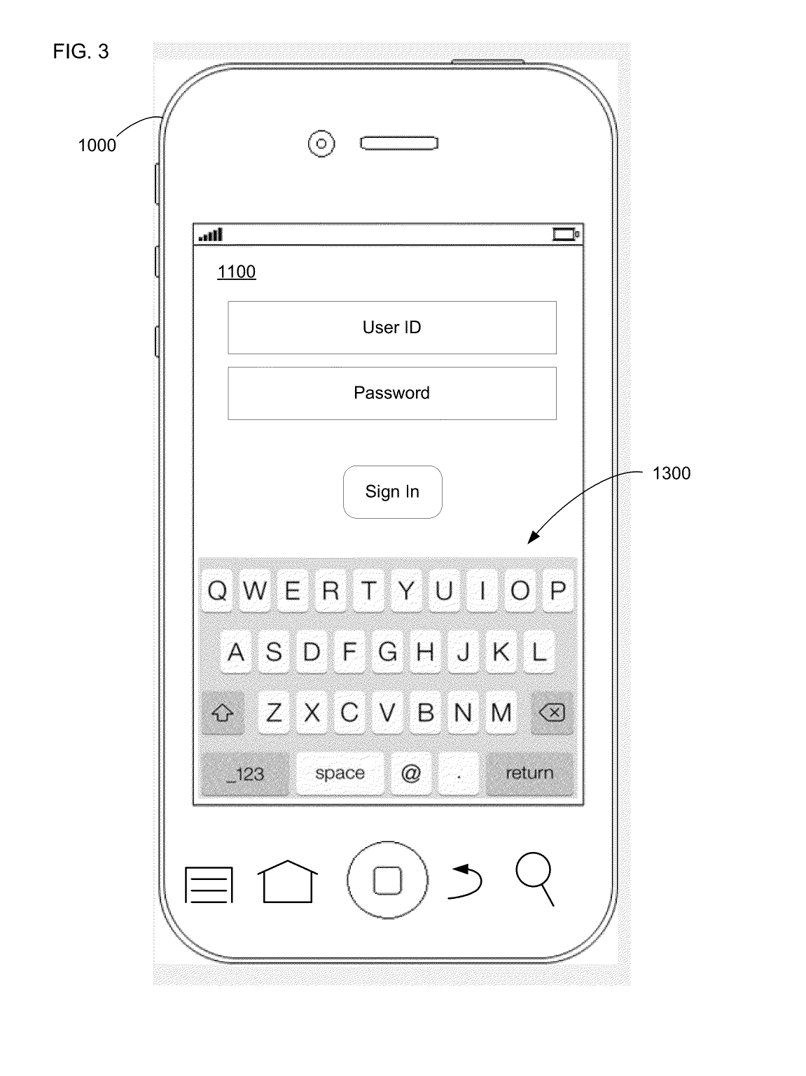

FIG. 3 illustrates a possible first step: After initiating the data capture application installed in the software stack of the mobile device 1000, the user may be required to sign in, for example, by entering a user ID and password in the normal manner, that is, by means of a physical or graphical input such as a keyboard 1300.

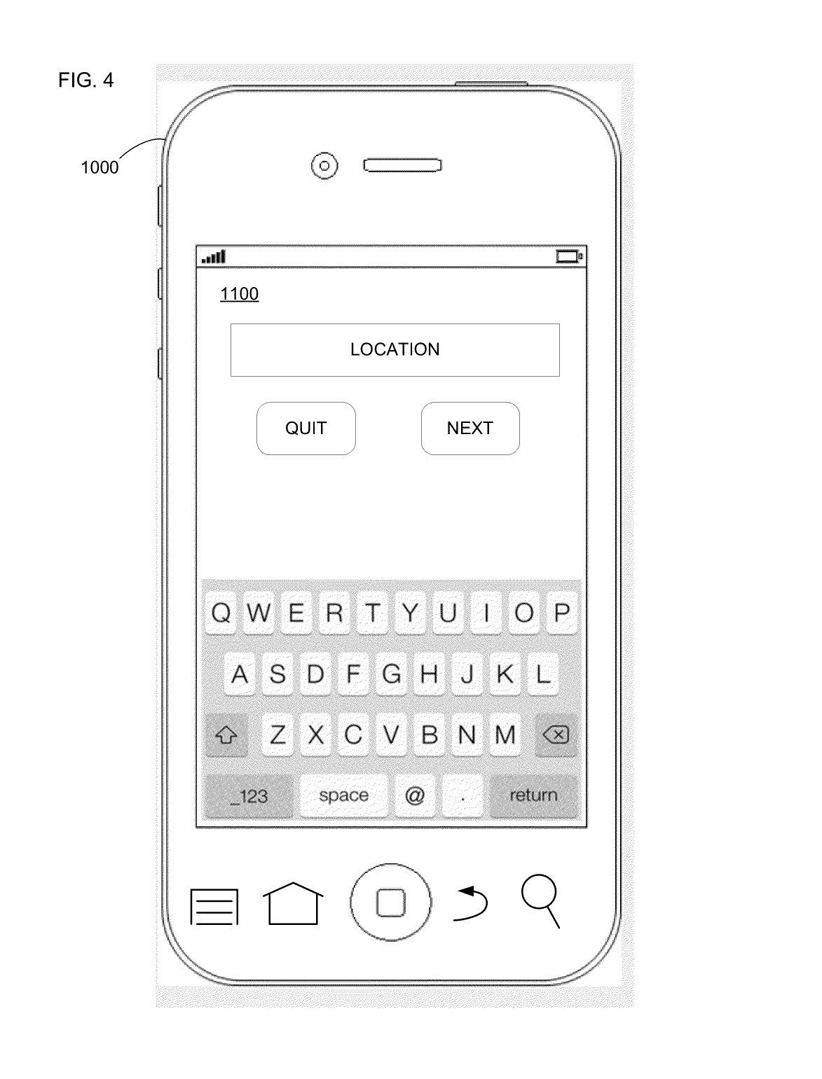

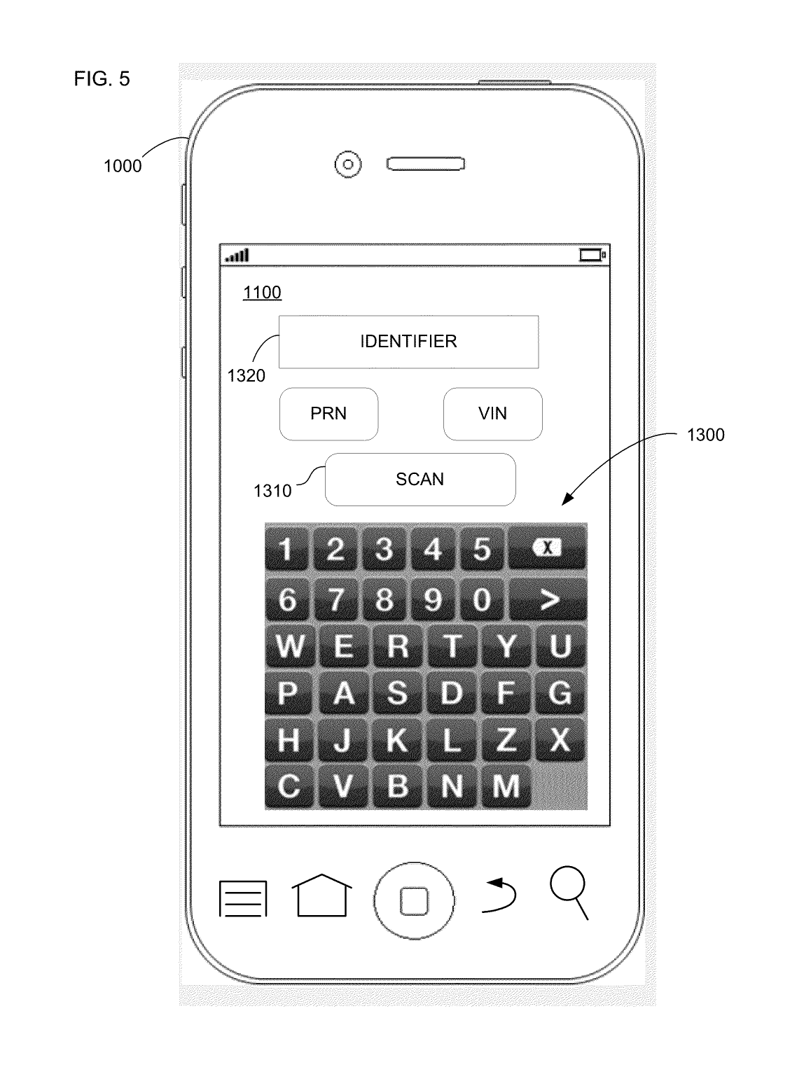

FIG. 4 illustrates a possible second step: The user may enter a location, such as the name of the city or facility, a location code (such as a standard airport code in the case of air freight), etc. This step, if included at all, might also be automated and therefore omitted if the mobile device has an on-board location capability 1015 (FIG. 5), such as a GPS engine or other geolocation routine such as those in most mobile telephones to determine location by relative cell phone tower signal strength. Automatic capture of location data would have the advantage that it would be more difficult to accidentally input incorrectly or even falsify. Of course both manual and automatically determined location information could be implemented.

FIG. 5 illustrates another possible step: The user inputs the item identifier, for example, a VIN. This input may also be either manual or at least semi-automatic. In the illustrated embodiment, the on-screen virtual keyboard 1300 displays a reduced character set that includes only the characters found in VIN numbers (“1”, “0” and “Q” are excluded to prevent confusion with “1” and “0”) applicable to VIN numbers assigned after the standardization of VIN numbers in 1981 by the National Highway Traffic Administration. For automatic or semi-automatic input of the item identifier, a sensor 1016 (such as Bluetooth, RFID, bar code reader, etc.) or camera 1017 (for example, together with bar code or QR code interpretation software) could be used to scan whatever marking is affixed to the item that encodes the identifier. The user may in such cases activate a graphical “Scan” device 1310 to initiate automated capture of the item identifier, which is then preferably displayed in an “Identifier” field 1320 so as to provide confirmation to the user of successful and accurate capture of this information.

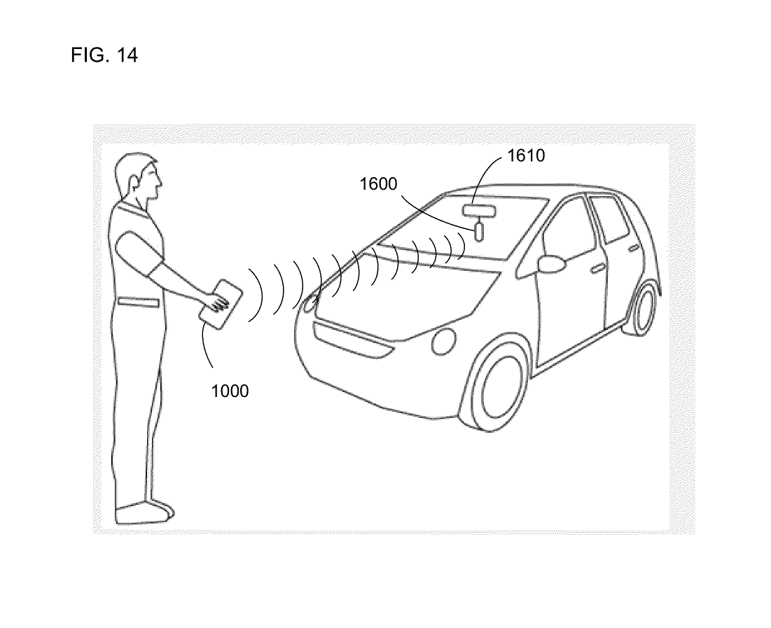

See FIG. 14. As one example of automatic item identification, that is, item identification that doesn't require the user to manually input the identifier, each item could be supplied with a transmitter, such as a Bluetooth transmitter 1600, or RFID device. A user could then simply walk near the item of interest 1610, or simply walk among many of them, and the mobile device 1000 may then automatically sense the item's encoded identifier, query the inspection server 4000 and associated database 220 over the network 2000, and download the proper identifiers (such as the PRN and VIN) and related data. Depending on accessibility to the server 3000, a query may be submitted to and answered by the database 210, using the identifiers downloaded from database 220, to access additional or updated shipment details such as the destination.

One advantage of this optional automatic ID-capture implementation is that the user would not need to maneuver a barcode scanner or camera or need to be close to the item to do so. Another advantage is that this would optionally allow capture of data for more than one item at a time, thereby avoiding the need for repeated, separate queries of the shipping and inspection servers before being able to perform inspections. Allowing the capture of more than one item at a time may also be used to generate a list of items within a distance adjustable by the user. For example the user may stand at the door of shipping container and be able to obtain a total count and details of every item within the container without either unloading the container or visually identifying each item. This is of considerable benefit where the items are tightly packed or physically unreachable within the confines of a shipping container.

One example of a technology suitable to implement automatic ID capture includes the class of Bluetooth Low Energy (BLE) devices, which enable wireless sensor beacons with batteries (such as the iBeacon system of Apple, Inc.). Using such a device in the vehicle, a signal can be captured by the mobile device, and, if more than one item is transmitting, such BLE devices, such as those operating with the Bluetooth 4.0 standard or later, the mobile device will be able to simultaneously retrieve data from all signals within a defined range, which can be made user-adjustable. In one embodiment, the data-capture application within the mobile device may then send information back to the Bluetooth device attached to the item to function as a marker that the Bluetooth device has been associated with data about the Item stored in database 220. The Bluetooth device may then store this informational marker, for example, as assigned.

If the battery power supplied to a transmitter such as a Bluetooth-enabled device is not expected to suffice throughout all the inspections in the supply chain, it would be possible to plug it into the electrical system of the item (such as a car) if it has one.

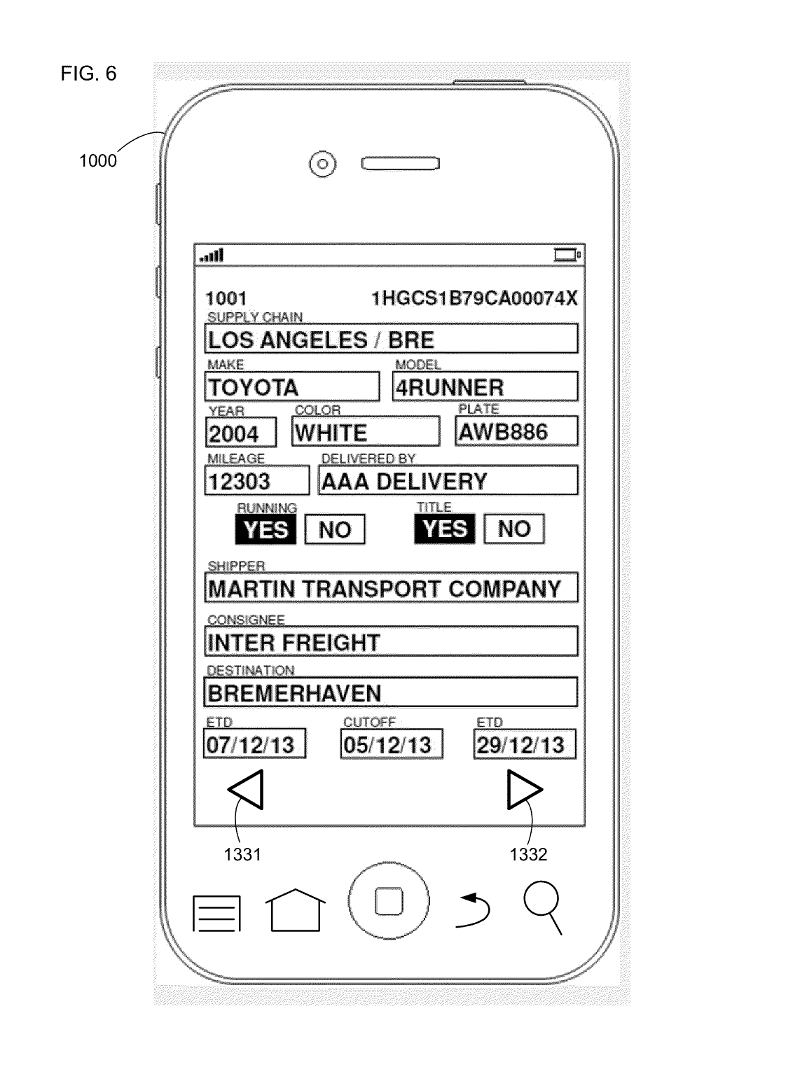

Regardless of the method implemented to capture the identity of the item of interest, using known log-in procedures, this information is then transmitted over the network 2000 to the inspection server 4000, which then validates the user's access and returns the data associated with the shipping and condition of the selected vehicle. FIG. 6 illustrates an example of the data that might be returned and displayed by the mobile device for the vehicle—a Toyota 4Runner—having the VIN 1HGCS1B79CA00074X. If additional data screens are to be displayed, the user can advance or return to them using a standard graphical method, such as by touching icons 1331, 1332.

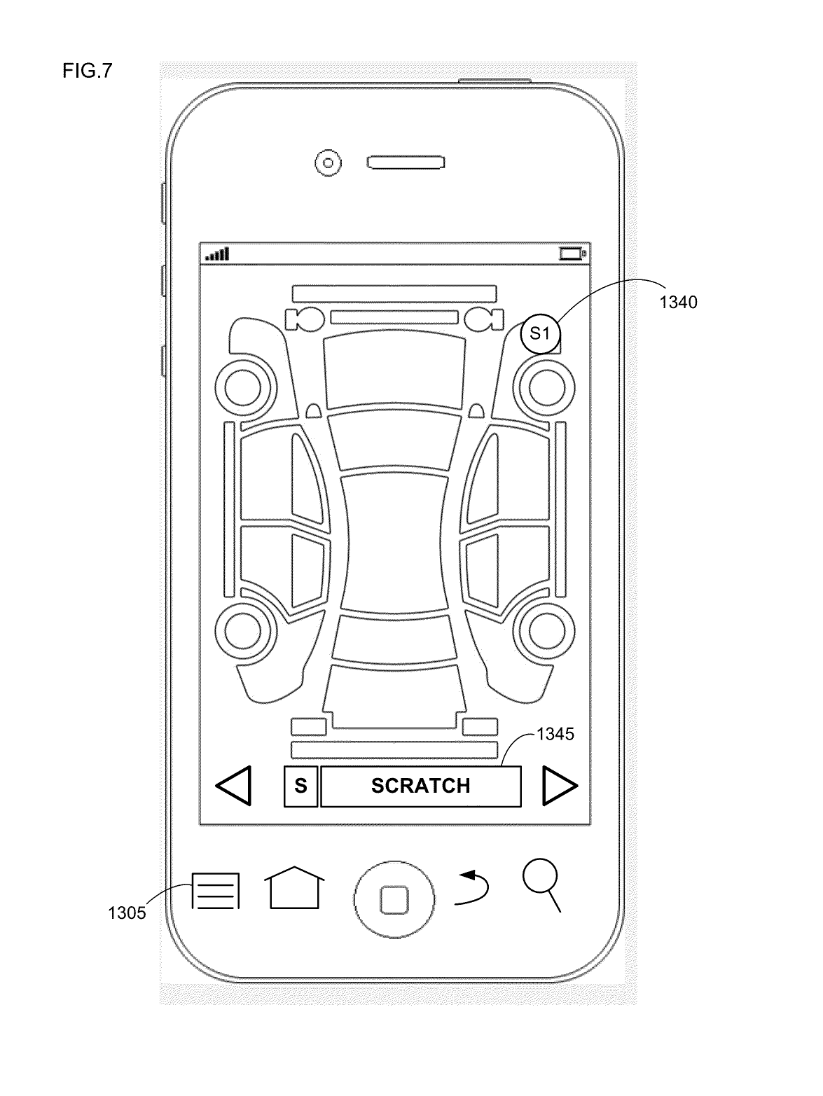

FIG. 7 illustrates a data input screen associated with the chosen VIN. The user may, for example, advance to this screen after viewing the data screen (FIG. 6), using the icons 1331, 1332, by “sliding” the display, or by selecting it in any other known manner, such as by touching a menu or option button 1305 on the phone display.

Any convention may be chosen to categorize detected exceptions according to the user (stage/step in the inspection chain), type, severity, etc. In the example embodiments described here, the following convention is used for the sake of convenience and clarity only: an exception marker/indicator Ei has type E and was entered into the system at stage i. In the context of vehicles, one naming convention could be such that Eε{S, D, B, M, G, W} where S: Scratch; D: Dent; B: Broken; M: Missing; G: Glass; W: Wear. Thus, S3 would indicate scratch found by the user in Stage 3; G1 would indicate something wrong with the glass found already at Stage 1; etc.

In preferred embodiments, users are able not only to enter the exceptions they see at their own stages, but also to view exceptions entered by previous users at earlier stages. Thus, a user at Stage 3 might observe and want to enter M3, but, depending on the implementation, may also be allowed to view previous exception entries such as S1, B1 and D2.

Assume that the vehicle at Stage 1, for example, is undergoing a final inspection before leaving the manufacturer 101, and the inspecting user notices a scratch on the front portion of the front right fender. See FIG. 7. After activating the display in any known manner, such as scrolling into it, the data capture application preferably generates on the display an exception selection field 1345, which the user may scroll or otherwise manipulate to choose what to note about the selected portion of the car, in this case, a scratch. Other methods may be used to present the list of exceptions to the user, such as a drop-down menu, displayed either adjacent to the indicated exception point, or on some other area of the display.

The Stage 1 user then may select the lower front region of the front right fender of the representation of the car, for example by touching the display screen with his finger or with a stylus or other device, by maneuvering a cursor, etc. Upon so touching the representation of a component (in this case, the fender), the data capture application may highlight or otherwise call out that component (to confirm the proper selection has been sensed), for example, by changing the displayed color of the component's representation, by making it brighter, or even by displaying corresponding text (such as “F R Fender for “Front Right Fender”, or “Grill” or “R Window”, etc.). After sensing the touch, the data-capture application generates a corresponding exception indicator/marker 1340 S1 at the point of touch.

Now assume the vehicle is transferred to Stage 2, that is, to the first Transporter 102 (FIG. 1) and assume that that user notices not only another scratch, on the front left area of the hood, but also a dent on the right rear quarter panel. At first, the data-capture application may display for this user the previous entries, which, in this example, is S1 as shown in FIG. 7.

In one embodiment, users may be allowed to see only the blank representation of the item (here, vehicle) and thus must enter each observed exception without knowledge of any previous entries. This not only simplifies the configuration and keeps the display screen as clear as possible, but also may provide a method to corroborate previously found exceptions and also to discover, over time, inspectors who are sloppy and who often miss exceptions.

Previously entered exception markers may be distinguished in any preferred manner. For example, previous exception markers could be color-coded, even with per-stage color coding, or (as in the Figures) be displayed along with a number defining at which stage the previous exception marker was noted. Another method would be to render previously entered exceptions more faintly, or with less hue.

Entered exceptions may then be transferred (such as by uploading via the network 2000) to the database 220 for viewing by whichever users, or the coordinator, or additional parties (such as auditors or insurance representatives, etc.) are authorized to view the entire chain of exception records.

In an alternative embodiment, the data-capture application allows the user to selectively display or conceal previous exception entries. One way to arrange this would be to display a graphical input device such as a radio button to toggle previous exception display ON/OFF, or with a list of previous stages, each with a radio button, whose entered exceptions are to be displayed or not. Another option could be a pull-down menu, selected for example via the option button 1305 or otherwise, allowing the user to select which, if any, of previous stages' exception markers are to be displayed.

Assuming users are allowed to view previous exception markers at all, the system administrator could also enable selective authorization to view previous exceptions. For example, the manufacturer 101 and the user at the final destination 105 could be authorized to view previous exception markers, but not the intermediaries such as the transporters or the storage facility representative.

See FIG. 8. Here, using the same procedure as described above, the user at Stage 2 has entered two new exceptions: the scratch S2 at the front left of the hood and the dent D2 on the rear left quarter panel.

Including the stage numbers (such as the “1”, “3”, in “S1”, G3”, etc.) in the display is not required, but is illustrated in the drawings merely for the sake of clarity and understanding. A current user/inspector will not generally need to know or see “his” stage number, for example, or even to see the actual stage numbers of previously entered interests. The numbers therefore need not be displayed to a current user, although they will still be associated with the users in the database 220 for proper review and analysis later.

In addition to choosing the type of exception, the data capture application could also generate for display a graphical input device such as a slider, or pull-down menu to enable the user to indicate the severity or size (or both) of an observed exception. Severity may be indicated in any suitable manner. For example, there might be choices such as “Minor”, “Moderate”, “Major”, etc. Another of the many possibilities could be a number representing the severity according to the 5-level AIAG Damage Codes. The user could then be presented with the possibilities, or could indicate such qualitative information by cycling through the possibilities depending on how many times the user taps the exception marker. For example, one tap could indicate “Minor”, two taps “Moderate”, and three taps “Major”, or could tap to cycle through 1-2-3-4-5-1- . . . A marker characteristic such as size, brightness or color could then be changed accordingly so the user knows which he has selected.

In another embodiment, any or all of the users, depending on administrator authorization, could be allowed to audit or question the legitimacy of a previous observation, or to annotate some other characteristic of an exception. Different methods could be implemented to accomplish this. For example, the user could touch and hold on a particular previous exception marker beyond a set threshold time, whereupon the data-capture application could generate for display any graphical input device to enable a comment entry field, or drop-down menu with entries such as “Dispute” or “Update”, etc. System designers may implement an embodiment of the invention to enable user input of any other characteristics of interest besides exception type, severity, etc. using the same methods as described above.

Note that one advantage of the illustrated embodiment is that an exception is associated with a particular and distinctly encoded and rendered component of the vehicle (such as the hood) but may also be associated with its location on the component (such as front left). In other words, in some implementations, just identifying on which component an exception is located may suffice. For example, the components associated with the exception might be small enough that the precise location within the component is not relevant. As another example, damage to a component might be “all or nothing”, that that is, any exception might be all an inspector cares about, possibly requiring replacement in every case. In other implementations, it will be preferred to be more precise as to the location of an exception, that is, even where on the component the exception is located. There are different ways to record and store such within-component locations. One way is arrange even the representations of the components as a set of sub-fields (not necessarily displayed to the user), such that the data capture system can sense the difference in location between different places the user touches. In other words, component Ci could in fact be a set of component portions Cij.

Another way to implement sub-component granularity in selection would be to sense an x-y position measured in linear units, in pixels, etc., relative to a pre-defined origin that in turn is relative to the display of the vehicle, such that it can later be displayed in the correct position when viewed by other users or by some other, such as an auditor who later reviews the inputs of the different actors. Such coordinate-based storage will often be preferable in the cases in which the representation of the vehicle is generated in vector-graphic form, which has the known advantage of reduced storage requirements (and thus lower bandwidth requirements) and ease of non-distorted resizing.

Still another way to enable easy location of exception indicators even on small details is to include a positive/negative magnification (zoom in/out) feature in the display 1200 so as to make it easier to place exception indicators on small parts (such as the mirrors or headlights, or to more accurately locate them. Any conventional method for enabling zooming of a mobile device's display may be used, including icons for + and −, or finger gestures such as “squeezing” two fingers together on the screen (to zoom out) or separating the fingers (to zoom in).

Known methods may be implemented to enable the user to remove, move or change an exception indication. For example, by touching the display of the indicator D2, the user could “slide” it with his finger to another position, and by holding steady on it, the system could display an option to delete it. Such options are found in many other instances on modern smart phones and tablets.

One other option that might be presented to the user upon holding steady on an exception indicator (such as D2), or by some other method such as via an option icon on the display, is the ability to enter textual comments, either in general, or associated with particular exception indicators. In such case, a keyboard such as illustrated in FIG. 4 could again be displayed (if a physical keyboard is not included in the particular mobile device).

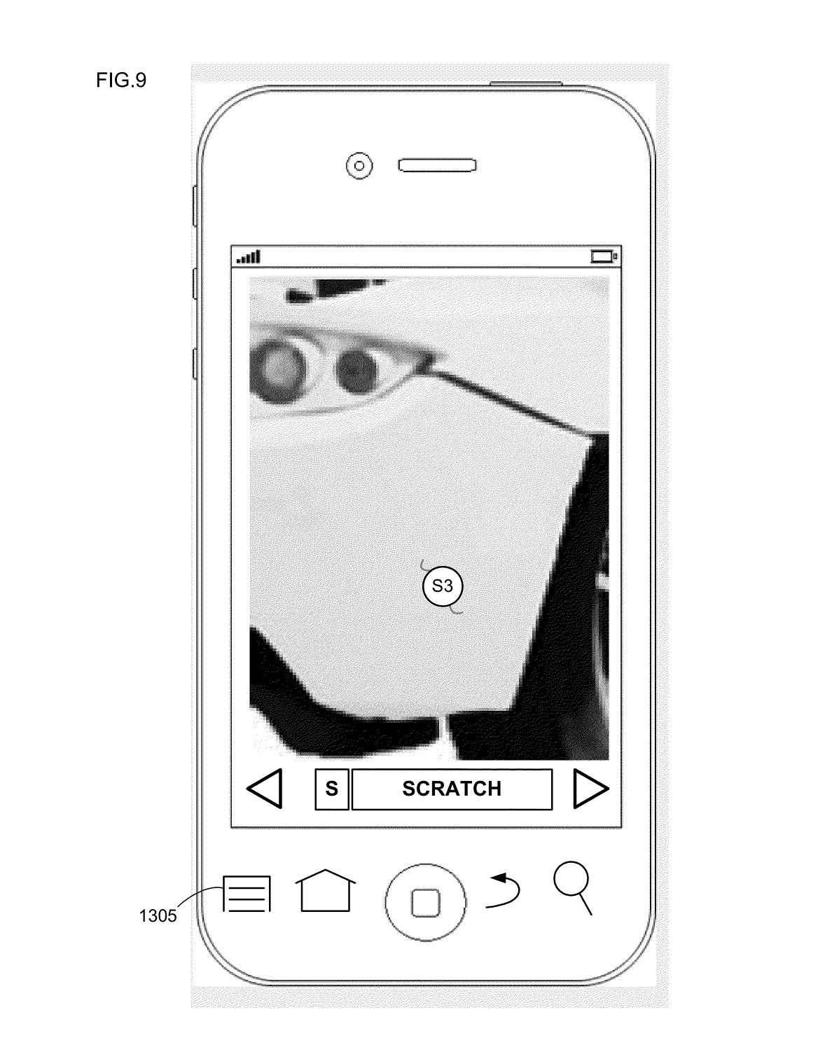

FIG. 9 illustrates another method for indicating exceptions that may be used together with the component-based input illustrated in FIGS. 7 and 8. In this embodiment, the user accesses a camera 1017 (FIG. 13) included in the mobile device to photograph the area of the vehicle associated with the exception, and, optionally, to again indicate the exception location and type (here, a scratch at S3—the “3” indicating the inspection was carried out in the third sequential inspection of the vehicle).

In one embodiment the photograph is correlated to an area of the vehicle, such as bumper-rear. For example, upon taking a photograph, the user could either select the component from a list, or could, for example, “copy” a position by touching on it on the 2-D representation, then touching the corresponding place on the photograph, etc. In another embodiment it may be possible to restrict or otherwise programmatically manage the placement of exceptions on photographs so they correlate to the exceptions on the diagram.

Although it would, in general, require greater bandwidth, a large database of different makes and models, and more storage, it would also be possible to transmit to the user's mobile device, for each selected vehicle, a pre-stored, 3-D rendering or even photo of the current vehicle. Using known graphics software, the user could then zoom in and out, and drag the displayed image on a 360° “virtual tour” of the vehicle and indicate exceptions on the rendering/photo. This would eliminate the need to represent the vehicle as components in the display field. On the other hand, by establishing a proper coordinate system, such as rotation angles for “pitch”, “yaw” and “roll” relative to a “null” position such as straight towards the front center of the vehicle, it would still be possible to fix and store the position of each exception indicator (such as the illustrated S3) relative to the displayed rendering/photo.

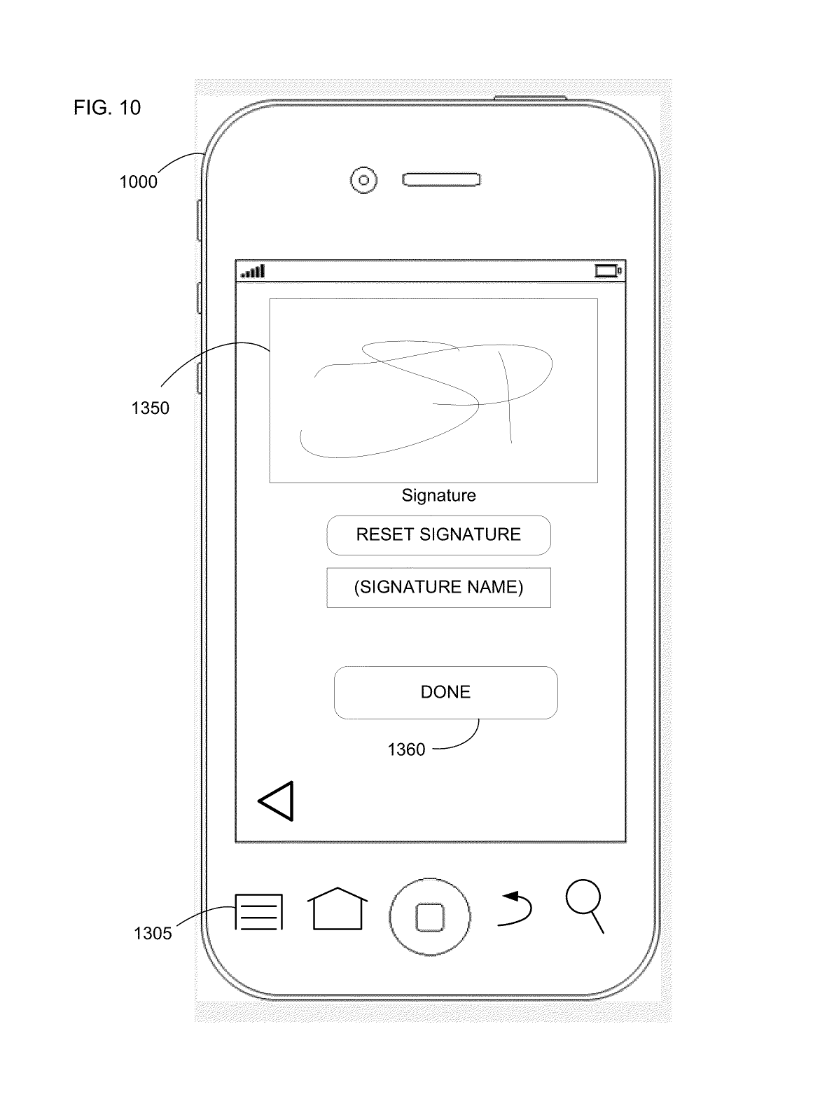

When the user has completed his inspection and indicated all the exceptions he's found that he wants to record and possibly annotate, he may advance to a “Commit” screen, illustrated in FIG. 10. Although many different procedures may be implemented to indicate that the user has finished inspecting the current item, in the illustrated case he does so by putting his signature in a signature field 1350 and then performing some finalization action such as touching on a “Done” icon, selecting some option such as “Send” from a menu activated by an appropriate icon such as 1305, etc.

Once the user has indicated completion of the current inspection, the data capture system uploads to the inspection server 4000 the captured data using any chosen format and protocol.

The inspection server 4000 preferably generates and stores, in database 220, information that identifies a particular chain of inspection for a given item, including such information as which item is involved, which users are authorized to enter inspection reports, etc. For example, some or all of the following might be included as entries (fields and tables) in the database 220 upon the start of a supply chain for delivery of a car:
Primary index information such as:
   PRN
   Item Identifier
   Electronically generated signal Identifier (if implemented)
   SGC—“Supply Chain Group (SCG)—which may be included as a designator of the set of users, defined by reference to their TenantID's (see below), authorized to participate in a given supply chain scenario. An item may be transferred from one SCG to another, in which case a record is kept in the database 220 as to which SCG the item currently belongs to.
   SessionID—an identifier generated by, for example, the inspection server 4000, to identify a particular inspection session. Subsequent communications or interactions between any device 1000 and the server 4000 may then require submission of the correct SessionID in order for a device 1000 to proceed with a request to enter or retrieve records.
Static item-specific data such as:
   PRN (again, as an index)
   Electronically generated signal Identifier (again, if implemented)
   Make
   Model
   Year
   VIN
Supply chain-related data such as:
   KEY—an integer-based primary key within the database(s) 210, 220 to reference a unique record, as is common in relational databases that include tables that interact with each other.
   PRN
   User ID
   TenantID
   Location (either by name or by geographic coordinates, or both)
   Date/Time
   Step—an identifier of the stage in the supply chain at which an inspection is reported
   SCG
Variable Data, which includes the reported exceptions:
   KEY
   For each entered exception:
   Exception codes (such as S, D, W, . . . )
   Exception codes related to component, exception type, severity, etc., formatted to customer or industry standards such as the 5-digit Automotive Industry Action Group (AIAG) Global vehicle Damage Codes Standard
   Component IDs
   Coordinates
   Textual annotations
   Image file(s)

The inspection database 220 may include records specifically related to the various users of the system. Examples of information that might be stored for each user include, for each user:
RolePK—a number that indicates what role(s) the user plays in the inspection chain. Examples of possible roles (which may be combined) referenced by the RolePK include: Administrator—Manages aspects such as creating users, assigning roles and creating Supply Chain Groups (SCG); and Inspector—Assigns a Supply Chain Group to the vehicle upon the initial inspection event, which defines which group of actors will handle the vehicle, be able to perform subsequent steps and have access to related shipment data.
UserPK—unique primary key used to index to the user's database entry
Username
TenantID
Password
Additional User Data such as:
   Email address
   Static Location
   Other rights and privileges granted to the User to create, modify and delete data and Application settings

The manner in which devices, both fixed and mobile, address a database over a network, are granted or denied access depending on proper identification, privilege level and authorization, indicate what records (in whole or part) they wish to retrieve for review or to upload for indexing and entry, are well known and any such method may be implemented in embodiments of this invention.

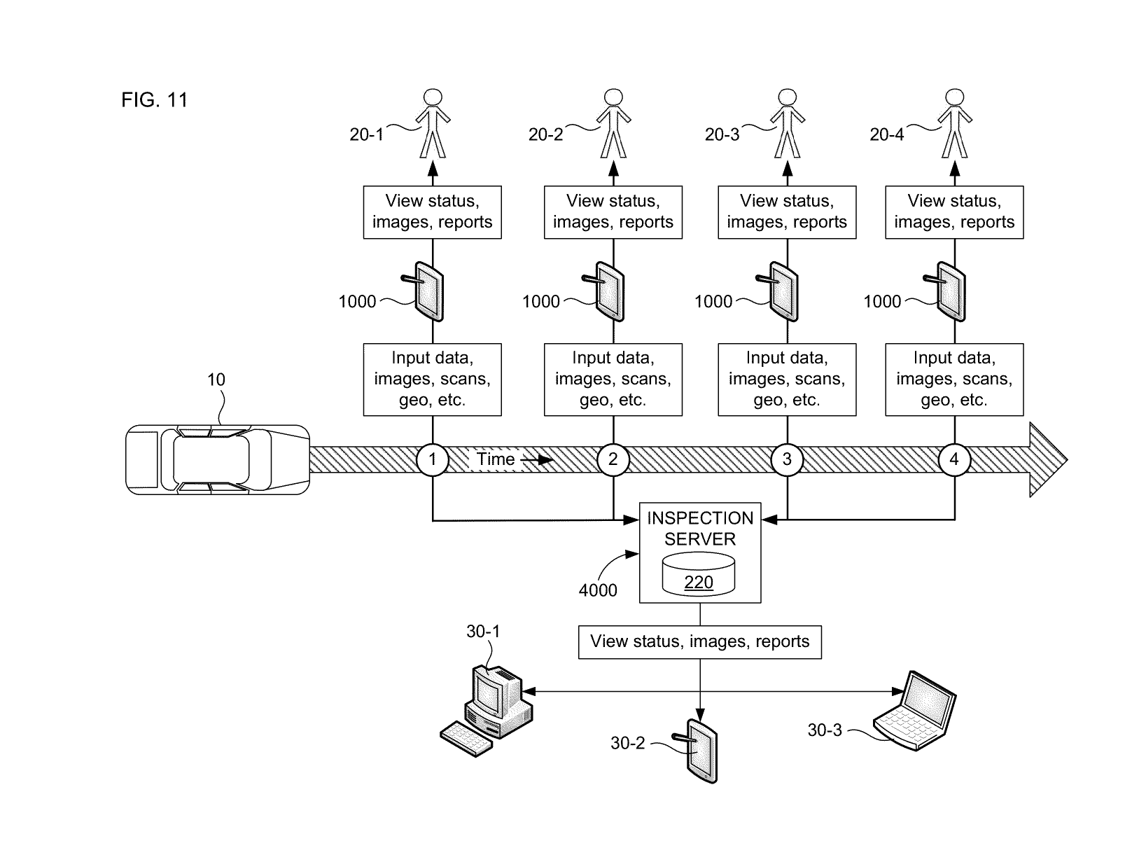

FIG. 11 illustrates a four-stage (Steps, indicated on the time line by respectively numbered circles 1-4) supply chain in which an item (vehicle 10) is inspected by four different users/actors 20-1, 20-2, 20-3, 20-4 using respective mobile devices 1000. For example, Step 1 might be the initial inspection by the manufacturer 20-1, before releasing the vehicle for shipment. Step 2 might be inspection by the representative 20-2 of a transporting entity, such as a shipping or rail line. Step 3 might be the inspection at an unloading dock by the representative 20-3 of a wholesale purchaser. Step 4 might be an inspection upon taking delivery by a car dealer 20-4. At each Step, the respective user may follow the procedures described by way of example above to connect with the shipment and inspection servers 3000, 4000, retrieve representations of the vehicle of interest, mark exceptions, possibly take photographs and make textual annotations, and upload their respective results for inclusion in the inspection database 220.

FIG. 11 also illustrates three “Inspectors” 30-1, 30-2, 30-3 whose role will be to look at reported, stored results, either partial or compiled, although they will typically not have been the ones to create this data. Such inspectors might include insurance representatives, auditors, other administrative personnel, etc. The transportation coordinator 110 could also be one of the Inspectors 30-1, 30-2, 30-3.

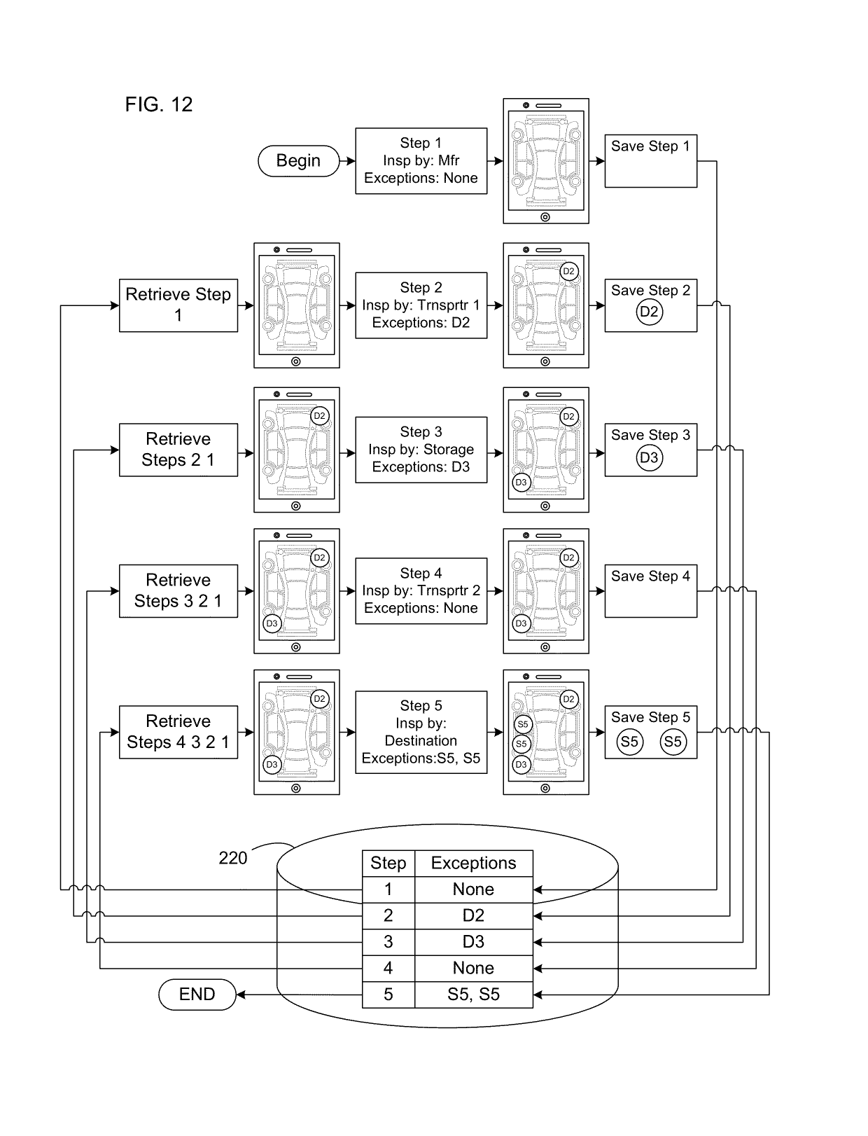

FIG. 12 illustrates the flow of information, and the change of displays, as users in a five-step inspection chain inspect a vehicle. After each inspection, newly entered exceptions are marked on the display and the data that defines and characterizes each exception are transmitted for storage as entries in the inspection database. At each step, in the illustrated embodiment, users are able to retrieve the exception information entered by the users earlier in the inspection chain. In the illustrated embodiment, no exceptions are found and entered at steps 1 and 4; dents were found at steps 2 and 3 (D2 and D3, respectively), and two scratches S5, S5 were found in step 5.

As mentioned above, an exception is defined and stored not only by type and step number (the Ei format), but will typically also include additional information such as, for example, the associated component identifier and position information such as coordinates, qualitative indications such as severity, comments, indications from users that an exception should be changed, deleted or moved, user IDs, inspection location, etc. Note that exceptions could also be indexed in the database per-component instead of per-step. In short, an exception E will be defined and stored as a vector or even matrix of information, with as many elements as are needed or desired in a particular implementation of the invention and depending on the type of item being inspected.

Note that the various embodiments are not restricted to use in a supply chain, but, as mentioned above, may be used even in an “iterative” inspection scenario. For example, each user might be the representative of a car rental agency and each “Step” might be the signing out and checking in of a particular car that a customer has rented, or a position in an assembly or manufacturing line or process. In many such cases, the inspection database record for the vehicle will be essentially “open-ended” in that the number of inspection reports submitted may in general not be knowable in advance. In these cases, the various identifying data for the different users and the format of exception storage may be changed to suit the needs of this type of implementation.

As mentioned above, an inspection scenario may involve even a single actor/user. It would in fact even be possible to implement ideas of the invention such as the interactive graphical display of components, and mapping of components to a consistent code system, in a single device, with no need to upload exceptions to any other system. For example, a single user might want for his own purposes to track exceptions of one or more items over time, or from one place to another. In this case, storage of exception data could be within the user's device itself, along with either a pre-stored component-code mapping, or with an ability to download codes as needed.

Local storage of exception data within a user's device 1000 may be useful even in multi-stage, multi-user scenarios. For example, exceptions that a user has entered for a given item could be stored locally, in the device's storage unit (such as a phone memory or its SD card, or a tablet's internal memory or an attached memory device). This would at least temporarily eliminate the need for the user's device to be connected to the network, at least for the sake of transferring exception data to an external, higher-level storage system such as the database 220.

Different methods may be used to transfer exception data from a user device to external storage. One way is via the network 2000, using normal network transfer protocols. Upon completion of an inspection session, the user can commit his entries, whereupon the data capture device causes them to be transferred. Another way would be for the portion of the mobile device's memory 1012 that holds exception data to be “synched” with a corresponding portion, such as a shared file, within the database 220, or of a portion of the memory in the server 4000. Still another method would be to store exception data on a removable storage medium such as a USB thumb drive and transfer this data to the server 4000 in any known manner.

FIG. 13 illustrates the main system components that can be used to implement various embodiments of the invention. Several of the components have already been referred to and described above. FIG. 13 illustrates only one user-level system 1000, that is, mobile device, which interacts with the shipments and shipment server 3000 and inspection server 4000 over the network 2000, but this is merely for the sake of simplicity. The other mobile devices will be configured similarly.

Each mobile device will have system hardware 1010, which will typically include one or more processors (CPUs) 1011 and one or more volatile and non-volatile memory devices 1012, which will store, among other temporary data, the non-volatile, computer-executable code that embodies the routines that perform the various functions described above. The system hardware will typically also include I/O controllers 1014 as needed to communicate with and control such input and selection devices or routines 1052 such as a various buttons (physical and virtual), touch-screen, sensors 1016 (such as RFID and Bluetooth sensors, optical scanners, etc., if included), a camera 1017, the display 1100, and their related drivers and supporting software. Depending on the implementation, a geolocation engine 1015 may also be included to provide location information. A network interface device 1018 corresponding to the network 2000 type is also included as part of the system hardware, but is show separate from the “box” 1010 merely for the sake of clarity.

System software 1020 will typically include some type of operating system (OS) 1022 and various drivers that are used for software control of physical devices and are typically installed in the OS itself. A graphical user interface (GUI) controller 1026 is also often an integral component of the OS and is used to generate the various interface devices by means of which the user interacts with and controls input and receives output data.

An application/user software layer 1030, which typically runs at the user level, is usually installed to run on the system software 1020. There are of course countless applications that might be installed on a mobile device 1000, but for the present purpose one application in particular is included, namely, the data capture software module 1040, which executes to provide the functions described above in connection with the discussion of FIGS. 1-11. The data capture software module includes components 1045, 1046—that is, portions of its computer-executable code—provided to render the representations of the item, the exception indicator(s), various input fields, etc., and to associate user input with the corresponding data fields.

The inspection server includes or is otherwise in communication with the database 220, which will as usual be implemented within one or more storage devices. The inspection server includes software components 4010, 4040, 4050 to validate users who contact the server, to extract data submitted by users and to format data for transmission to the users, and to associate extracted data with the proper records and fields in the database 220. The general server 3000 will include similar software components as 4010, 4040, and 4050, but these are not shown merely for the sake of simplicity.

The general and inspection servers 3000, 4000 will also include system hardware and software components similar to those found in other severs, such as CPU(s), volatile and non-volatile memory and storage devices, network interface devices, I/O devices, an operating system, user-level applications such as administrative routines, etc. These are not shown in FIG. 13 merely for the sake of simplicity and because this is well known.

The various embodiments of the invention offer several advantages over the prior art. One is component-level “granularity” for exception input which, when coupled with the (optional) sub-component level coordinate data that can locate at least approximately where on the component an exception has occurred, gives users a much better ability to isolate such exceptions. In prior art systems, one may know that there is a scratch roughly near the front of the right side of a vehicle, for example, but not necessarily be able to identify what component is involved.

Yet another advantage of separate per-component or sub-component exception capture and database storage is that it makes it much easier to detect patterns of damage not only for an individual vehicle, but for multiple vehicles in the same or similar supply chain. If, for example, the transportation coordinator 110, or some other reviewer, examining the exception records in the database 220, notices frequent exception relating to the top of the roof at the end of a transport stage with a particular carrier, then this will be an alert to check the loading or securing procedures and environment of that carrier.

Although exception type/component/location information will be useful to help identify where in the supply chain an exception may have arisen, it might also be used “proactively”. For example, (see FIG. 1) assume that the actor at the Storage Facility 103 inspects a vehicle in transit and observes that the front bumper is severely damaged or a particular window is cracked and will need to be replaced. The inspection database server 4000 could be programmed, using normal methods, to flag any such exception and notify, for example, the actor at the destination 105 or the transportation coordinator 110, who could then make sure that the required spare part(s) are ordered or otherwise available and ready to install on the vehicle when it arrives at the destination; this may thus save delay and help meet delivery schedules to the end buyer.

In FIGS. 7 and 8, among others, the item (in this example, car) is rendered as an “exploded”, component-based view that shows the exterior surfaces. By extending the information included in an exception vector E, other embodiments may be adapted to even other geometries, for example, to enable inspection not only of exterior surfaces, but also (or instead) interior components. For example, assume that the invention is to be used to enable compilation of accumulated exception information for a structure, such as a house, either in the process of construction, or for sale by a real estate agency. The house could be uniquely identified, not by VIN, but by any other agreed-upon system identifier such as those issued by permitting or tax authorities, according to industry identifiers such as the Multiple Listing Service (MLS) listing numbers used by many realtors, by an internal project number used by a general contractor, etc.

The geometry and configuration of the house that identify main components of interest may then be stored and mapped according to components based on pre-stored construction and floor plans. The components of the exterior of the house may then be labeled/indexed and rendered in a manner analogous to those for a car (roof, north/south/west/east walls, windows, front, rear, side, garage doors, etc.). But the interior components may also be rendered so as to enable user-input of exception markers with corresponding type indications (scratch, missing paint, broken glass, exposed wiring, etc.).

As just one of many examples of how inspecting users could “navigate” both inside and outside the house, the data capture application could generate, for example, via the option button 1305 or as an on-screen pull-down menu, one or more input windows in which the user may indicate, for example, by touch, such options as “Exterior”, “Interior Ground Floor”, “Interior Upper Floor”. An interior selection would then lead to display of the corresponding floor plan, which is rendered as components in the form of such features as rooms, hallways, shower areas, etc. Even sub-area granularity could be implemented, for example, by allowing the user to zoom in or out of a particular area, which can then be rendered in a 2-D “exploded” view or using 360° rendering graphics as with a car, but with each wall, the floor, ceiling, windows and doors as separate and separately selectable display components.

Of course, the interiors even of vehicles and other items could similarly have their components globally encoded and mapped to selectable rendering on the user's display.

As yet another alternative display and component rendering method, instead of rendering all the components at once, on a single display, as shown in FIGS. 7 and 8, the system could instead present the components individually and sequentially to the user on the display, in a customized, sequential order. By requiring the user to at least indicate consideration of each component, for example simply by him scrolling to or otherwise selecting the next component in sequence, the display will also function as a kind of “check list” to ensure that all important components are inspected. Such a sequential display may also be advantageous in cases where sub-component selection is often desired, such that sub-components of a component can be rendered visible all at once, avoiding the need to zoom in to select them.

What is claimed is:

1. A method for enabling inspection by at least one current user of an item, comprising:
inputting into a user device an identifier of the item;
retrieving into the user device representation data corresponding to a plurality of components of the item;
displaying for the current user an interactive graphical representation of at least one of the components;
sensing selection by the current user of at least one exception type corresponding to a respective exception;
sensing selection by the current user of the at least one component representation;
displaying on the at least one selected component representation an exception indicator corresponding to the selected exception type; and
transferring to a data storage medium exception data identifying and associating each exception with its respective selected component representation;
in which the plurality of components of the item is mapped to a respective code system that is component-specific with respect to the item.

2. The method as in claim 1, in which the step of transferring the exception data to the data storage medium comprises uploading the exception data over a network.

3. The method as in claim 1, further comprising:
sensing indication by the current user of a position of the exception relative to the selected component representation; and
including in the uploaded exception data coordinates of the indicated position relative to the selected component representation.

4. The method as in claim 3, further comprising retrieving into the user device at least one previously entered exception indicator entered by a previous user and displaying the at least one previously entered exception indicator together with the item component associated with the previously entered exception indicator.

5. The method as in claim 4, in which the code system is common to both the current user and the previous user, such that the component representation is consistent across user devices.

6. The method as in claim 4, further comprising:
sensing selection by the current user of the displayed previously entered exception indicator;
sensing entry by the current user of additional information relating to the previously entered exception indicator; and
uploading the additional information to the database.

7. The method as in claim 1, in which the step of retrieving the representation data corresponding to the plurality of components of the item is according to the item identifier, such that the selected component representation is item-specific.

8. The method as in claim 1, further comprising sensing a qualitative indication of at least one of the exceptions and including the qualitative indication as part of the corresponding exception data.

9. The method as in claim 1, further comprising inputting the identifier of the item automatically by sensing, via the user device, and interpreting identifying information affixed to the item.

10. The method as in claim 9, further comprising sensing the identifier as a wireless signal transmitted from a transmitting device located with the item.

11. The method as in claim 9, in which the step of sensing the identifier comprises scanning an optically readable marking that is associated with the item identifier.

12. The method as in claim 1, in which the graphical representation is a two-dimensional exploded view of the item.

13. The method as in claim 1, in which the graphical representation is an interactively maneuverable three-dimensional rendering of the item.

14. The method as in claim 1, further comprising displaying the interactive graphical representation as a sequence of individual representations of the components.

15. The method as in claim 1, further comprising:
sensing user indication of desired magnification of at least one of the graphically represented item components and magnifying the displayed graphical representation accordingly; and
sensing the selection by the current user of the at least one component representation within the magnified displayed graphical representation.

16. The method as in claim 1, further comprising:
creating a photographic image of at least one of the item components;
sensing selection by the current user of a portion of the image;
sensing indication in the image by the current user of at least one exception at a position on the image corresponding to an observed position of the exception on the item; and
including the position of the exception on the image in the uploaded exception data.

17. The method as in claim 1, in which the item is a vehicle; the identifier is a Vehicle Identification Number; and the components are parts of the vehicle.

18. The method as in claim 1, further comprising sensing a current location of the item and including corresponding current location data in the uploaded exception data.

19. The method as in claim 1, further comprising inputting textual exception information from the current user; associating the textual exception information with a corresponding one of the exception indicators; and uploading the textual exception information as part of the exception data.

20. An input device enabling inspection by at least one current user of an item, comprising:
a display;
at least one non-transitory storage unit;
at least one processor capable of executing instructions stored in the storage unit;
an input selection sub-system configured to sense user selection via the display of an identifier of the item;
a data capture module comprising processor-executable instructions for:
retrieving, over a network, into the user device representation data corresponding to a plurality of components of the item;
causing the display to display for the current user an interactive graphical representation of at least one of the components;
sensing selection by the current user of at least one exception type corresponding to a respective exception;
sensing selection by the current user of the at least one component representation;
causing the display to display on the at least one selected component representation an exception indicator corresponding to the selected exception type; and
uploading to a database exception data identifying and associating each exception with its respective selected component representation;
in which the plurality of components of the item is mapped to a respective code system that is component-specific with respect to the item and common to all users' devices.

21. The device as in claim 20, in which the data capture module further comprises processor-executable instructions for:
sensing, via the display, indication by the current user of a position of the exception relative to the selected component representation; and
including in the uploaded exception data coordinates of the indicated position relative to the selected component representation.

22. The device as in claim 21, in which the data capture module further comprises processor-executable instructions for retrieving into the user device at least one previously entered exception indicator entered by a previous user and causing the display to display the at least one previously entered exception indicator together with the item component associated with the previously entered exception indicator.

23. The device as in claim 20, in which the selected component representation is item-specific.

24. The device as in claim 20, further comprising a sensor for sensing and inputting the identifier of the item automatically.

25. The device as in claim 24, in which the sensor is a wireless signal receiver configured to sense a wireless signal from a transmitting device located with the item.

26. The device as in claim 24, in which the sensor is an optical sensor configured for scanning an optically readable marking that is associated with the item identifier.

27. The device as in claim 20, further comprising a camera for creating a photographic image of at least one of the item components;
said data capture module further comprising instructions for causing the input selection sub-system to sense selection by the current user of a portion of the image; for sensing indication in the image by the current user of at least one exception at a position on the image corresponding to an observed position of the exception on the item; and for including the position of the exception on the image in the uploaded exception data.

28. The device as in claim 20, in which the item is a vehicle; the identifier is a Vehicle Identification Number; and the components are parts of the vehicle.

29. The device as in claim 20, further comprising a location sensor sensing a current location of the item, whereby sensed current location data is included in the uploaded exception data.

30. The device as in claim 20, further comprising a keyboard for inputting textual exception information from the current user, said; said data capture module further comprising instructions for associating the textual exception information with a corresponding one of the exception indicators and uploading the textual exception information as part of the exception data.

31. A method for enabling inspection of items, comprising:
receiving, via a network, identification information from a current user who is inspecting the item, as well as an item identifier;
returning, to the current user, representation data corresponding to a plurality of components of the item, said representation data being item-specific and associated with the item identifier;
inputting exception data from the from the current user, said exception data including portions indicating per-component types and positions of user-identified exception; and
storing the exception data per-user and per-component in an item-associated record in a database;
in which the plurality of components of the item is mapped to a respective code system that is component-specific with respect to the item and common to all users' devices.

32. The method as in claim 31, further comprising retrieving from the database and transferring to the current user exception data for the components of the item previously received from previous users.

33. The method as in claim 31, in which the item is a vehicle; the identifier is a Vehicle Identification Number; and the components are parts of the vehicle.
